(19) United States
(12) Patent Application Publication
(10) Pub. No.: US 2026/0336043 A1
(43) Pub. Date: Oct. 29, 2026

(54) Method and Apparatus for Feeding and Processing Circular-Cylindrical Workpieces

(71) Applicant: KUKA Deutschland GmbH, Augsburg (DE)

(72) Inventors: Klaus Schneider, Friedberg (DE); Otmar Fischer, Augsburg (DE); Michael Buechler, Friedberg (DE); Andy Pham, Augsburg (DE); Thomas Hauck, Kissing (DE)

(73) Assignee: KUKA Deutschland GmbH, Augsburg (DE)

(21) Appl. No.: 19/656,196

(22) Filed: Apr. 23, 2026

(30) Foreign Application Priority Data
Apr. 23, 2025 (DE) DE102025115611

(51) Int. Cl. B23K 37/0538; B23K 101/04; B65G 1/04

(52) U.S. Cl. CPC B23K 37/0538; B65G 1/04; B23K 2101/04; B65G 2201/0217

(57) ABSTRACT

A method for automatically feeding and/or unloading workpieces at a machine tool for rotary processing tubular or circular cylindrical workpieces includes, among other things, guiding at least one steady rest by an automatically controllable handling device such that the handling device grasps a workpiece from a first workpiece store using the steady rest and receives it into the steady rest. The workpiece carried by the steady rest is moved by the handling device into a processing position and/or the handling device removes the workpiece grasped by the steady rest from the processing position, moves it to the second workpiece store and deposits it there by automatically releasing the steady rest. During processing of the workpiece by a machine tool, the workpiece in the steady rest is guided by the handling device holding the steady rest in a guide position corresponding to the processing position of the workpiece.

### CROSS-REFERENCE TO RELATED APPLICATIONS

This application claims the benefit of priority under 35 U.S.C. § 119(a) to German Patent Application No. DE 10 2025 115 611.5, filed Apr. 23, 2025, the disclosure of which is incorporated by reference herein in its entirety.

### TECHNICAL FIELD

The invention relates to a method for automatically feeding and/or unloading workpieces at a machine tool for rotary processing of tubular or circular cylindrical workpieces, including the steps of providing workpieces to be processed at a feeding first workpiece store next to the machine tool, providing an unloading second workpiece store for receiving workpieces processed in the machine tool, and providing an automatically controllable handling device for automatically removing a workpiece from the first workpiece store and positioning the removed workpiece in a processing position in the machine tool and/or for automatically removing the processed workpiece from the processing position in the machine tool and placing the processed workpiece in the second workpiece store. The invention also relates to an associated handling device and to an associated processing system.

### BACKGROUND

WO 2016 075 218 A1 describes a press welding device with a plasticizing device and a shrinking device as well as a holder for the components to be welded and a machine frame, wherein the press welding device has a machine head and a shrinking head which are movable relative to each other along a machine axis, wherein the holder has a component receptacle mounted on the machine frame in a manner that allows it to float between the machine head and the shrinking head and a preferably automatic adjusting device for adapting to different component dimensions, in particular component lengths.

The object of the invention is to provide a method for the automatic feeding and/or unloading of workpieces from a machine tool for rotary processing of tubular or circular cylindrical workpieces, as well as a corresponding handling device and a processing system, by which the workpieces can be processed in the machine tool with short cycle times.

The problem is solved by a method for the automatic feeding and/or unloading of workpieces from a machine tool for rotary processing of tubular or circular cylindrical workpieces, comprising the steps of:
providing workpieces to be processed in a feeding first workpiece store next to the machine tool,
providing an unloading second workpiece store for receiving workpieces processed in the machine tool,
providing an automatically controllable handling device for automatically removing a workpiece from the first workpiece store and positioning the removed workpiece in a processing position in the machine tool and/or for automatically removing the processed workpiece from the processing position in the machine tool and placing the processed workpiece in the second workpiece store,
guiding at least one steady rest by means of the automatically controllable handling device such that the handling device grasps a workpiece from the first workpiece store by means of the at least one steady rest and receives it into the steady rest, the workpiece carried by the steady rest is moved by the handling device into the processing position and/or the handling device removes the workpiece grasped by means of the at least one steady rest from the processing position, moves it to the second workpiece store and deposits it there by automatically releasing the at least one steady rest, wherein during processing of the workpiece by the machine tool, the workpiece in the at least one steady rest is guided by the handling device holding the at least one steady rest in a guide position corresponding to the processing position of the workpiece.

On machine tools for the rotary processing of tubular or circular cylindrical workpieces, it is practical and desirable to automatically insert the workpieces to be processed into the machine tool and to automatically remove them again after processing in the machine tool. Up to now, robot arms have been used for this purpose, which have special grippers to be able to automatically grip a workpiece and deposit it in the processing position on the machine tool.

In the rotary processing of workpieces in a machine tool, it is known to use steady rests, which are parts of the machine tool and can either be rigidly fixed to the machine bed or mounted on slides on the machine bed in such a way that they can be adjusted linearly parallel to the axis of rotation of the machine tool or of the rotating workpiece to be processed. The steady rests serve to guide and/or support the rotating or stationary workpiece during its processing in the machine tool, for example to prevent or at least reduce, to the extent necessary, unwanted deflections or vibrations of the workpiece during processing in the machine tool.

Typical steady rests mounted on the machine bed of the machine tool feature, among other things, a linearly adjustable clamping ram and two pivotably adjustable clamping arms that can be moved synchronously so that the center of all component center axes is identical across the entire possible diameter range of the steady rest. Clamping rams and clamping arms each have a bearing point with which a tubular or circular cylindrical workpiece inserted into the steady rest is guided in the steady rest. The respective bearing point can, for example, have a roller rotatably mounted at the distal arm end of the clamping arm, which roller rolls on the outer shell wall of the workpiece when the tubular or circular cylindrical workpiece is rotated in the steady rest. Depending on the length of the workpieces to be processed, only a single steady rest is necessary to support the workpiece, or for longer workpieces a plurality of steady rests are required, which are arranged at predetermined distances from each other on the machine bed and are in a common alignment.

However, a disadvantage of known automated systems is that, for example, a robot arm has to remove the workpiece to be processed from a workpiece store and deposit it into the open steady rest or into the plurality of open steady rests, and then the robot arm has to release the workpiece and be moved out of the working region of the machine tool. Similarly, the same or a different robot arm must be provided which grips the workpiece that has been finished in the machine tool again and lifts it out of the processing position in the steady rests and deposits it in another workpiece store. The transfer of the workpiece between a gripper of the robot arm and the steady rests is critical in its coordination of movements and requires a certain amount of time. This time spent transferring the workpiece increases the cycle times for processing a workpiece. Consequently, the processing throughput is rather low.

To overcome this disadvantage, it is therefore proposed according to the invention that the method is carried out in such a way that at least one steady rest is guided by means of the automatically controllable handling device such that the handling device grasps a workpiece from the first workpiece store by means of the at least one steady rest and receives it into the steady rest, the workpiece carried by the steady rest is moved by the handling device into the processing position and/or the handling device removes the workpiece grasped by means of the at least one steady rest from the processing position, moves it to the second workpiece store and deposits it there by automatically releasing the at least one steady rest, wherein during processing of the workpiece by the machine tool, the workpiece is guided in the at least one steady rest by the handling device holding the at least one steady rest in a guide position corresponding to the processing position of the workpiece.

In contrast to conventional systems, in which the steady rests are attached to the machine bed of the machine tool and at most mounted to be linearly movable on it, the invention provides that the at least one steady rest, or the plurality of steady rests, are arranged on the handling device, so that the handling device can move the steady rests separately from the machine tool and position them in space. The at least one steady rest, or a plurality of steady rests, are thus also used in the function of a gripper. Accordingly, the handling device moves the at least one steady rest towards the first workpiece store, so that the unprocessed workpiece can be grasped and held from the first workpiece store by means of the at least one steady rest. A movement of the handling device then moves at least one steady rest together with the workpiece out of the first workpiece store. The handling device therefore moves at least one steady rest together with the workpiece into a processing position in the machine tool, in which the workpiece held by the at least one steady rest and positioned by the handling device can be processed by the machine tool. The handling device thus positions the at least one steady rest relative to the machine tool. This means that at least one steady rest does not need to be directly connected to the machine bed of the machine tool.

This also has the advantage that the workpiece, once grasped and removed from the first workpiece store, does not need to be transferred again to stationary steady rests. The time otherwise required for releasing the item by the handling device and separately inserting it into the steady rests can therefore be eliminated. Furthermore, it is not necessary for the insertion into the steady rests to take place in the actual processing position, as in the prior art, but rather the insertion of a workpiece into the steady rests, which are moved by the handling device, already takes place in the region of the workpiece store and not in the processing position on the machine tool. Consequently, for example, a first handling device can already pick up a workpiece in the region of the workpiece store into first steady rests of the first handling device, while second steady rests of a second handling device hold a workpiece currently being processed on the machine tool in the processing position.

The automatic guiding of at least one steady rest can be carried out by means of the handling device between an initial position at the first workpiece store and the processing position in the machine tool and/or between the processing position in the machine tool and an end position at the second workpiece store synchronously with an automatic opening movement and/or closing movement of at least one clamping arm of the steady rest which is synchronously adjustably mounted on a main body of the steady rest between an open position and a closed position.

The technical solution according to the invention is equally applicable when only a single steady rest is moved by means of the handling device, for example in the case of short tubular or circular workpieces, or when a plurality of steady rests are moved together by means of the handling device, for example in the case of very long and/or heavy tubular or circular workpieces. When a plurality of steady rests are mentioned below, this also means that in special cases only a single steady rest may be provided.

Particularly long and/or heavy tubular or circular workpieces can, in a specific application, be drill strings, as used in drilling rigs for drilling through layers of earth. Such drill strings can have diameters of, for example, 35 to 300 millimeters and axial lengths between 0.5 and 15 meters. Such drill strings are fitted with threaded pieces or other connectors at their axial end ends, for example by friction welding. The machine tool used can therefore be a press welding machine, a friction welding machine, a rotary friction welding machine or a magnetic arc welding machine.

Especially larger types of such drill strings cannot be handled manually due to their high weight, for example several hundred kilograms, but must be moved using automatically controllable handling devices.

A synchronous movement of the adjustably mounted clamping arms of the steady rests between their open and closed positions, in relation to the movement of the handling device between the processing position and the starting position at the first workpiece store or the end position at the second workpiece store, does not mean that these two types of movement must begin and end simultaneously, but rather that the movements of the adjustably mounted clamping arms of the steady rests between their open and closed positions are coordinated with the movement of the handling device between the processing position and the starting position at the first workpiece store or the end position at the second workpiece store, such that the clamping arms of the steady rests are open, or are opened or closed, when the handling device is moved towards the first or second workpiece store, and the clamping arms of the steady rests remain in their closed positions as long as a workpiece is being moved by the handling device and as long as a workpiece is currently being processed in the processing position in the machine tool. In this respect, the two types of movement are coordinated and synchronized.

In these methods, a C-shaped steady rest can be used, and the automatic guiding of at least one C-shaped steady rest by means of the handling device can be carried out in such a way that, while holding the workpiece by means of the C-shaped steady rest in the processing position in the machine tool, the C-shaped steady rest is guided in such a way that the radial opening of the C-shaped steady rest points downwards.

A C-shaped steady rest as such can have a main body on which, for example, a linearly adjustable clamping ram and a jaw-shaped clamping arm or two jaw-shaped clamping arms are pivotably mounted between an open position, in which a workpiece can be inserted in a radial direction into a receiving position on the C-shaped steady rest, and a closed position, in which the clamping arms enclose the inserted workpiece by more than 180 degrees. The clamping ram and each clamping arm can have a bearing point at its distal arm end, which, for example, supports a roller rotatably mounted at the distal arm end of the clamping arm, which, in the closed position, rolls on the outer shell wall of the workpiece when the tubular or circular cylindrical workpiece is rotated in the steady rest. A third bearing point can be formed on the main body. The third bearing point can also be a rotatably mounted roller, which, in the closed position of the clamping arms, rolls on the outer shell wall of the workpiece when the tubular or circular cylindrical workpiece is rotated in the steady rest. The third bearing point can be arranged on the main body between a first clamping arm and a second clamping arm. The third bearing point can be linearly adjustable on the main body, in a radial direction toward or away from the workpiece.

By guiding the C-shaped steady rest in such a way that the radial opening of the C-shaped steady rest points downward while holding or guiding a workpiece, in particular in the processing position on the machine tool, the workpiece can be held above the workpiece in the processing position on the machine tool from a support position or from a gripping position of the C-shaped steady rest. After releasing a workpiece from the C-shaped steady rests, the released C-shaped steady rests can be moved away from the workpiece with a movement that has an upward directional component. This is particularly useful in the processing position of the workpiece in the machine tool, so that the released C-shaped steady rests can be moved away from the machine tool in an upward direction. The C-shaped steady rests therefore do not need to be threaded out from below the workpiece in the processing position between the machine bed and the workpiece.

Accordingly, the steady rest can have at least one clamping arm adjustably mounted on a main body of the steady rest between an open position and a closed position, wherein, after a workpiece has been grasped and picked up by the steady rest guided by the handling device, the closed position of the at least one adjustably mounted clamping arm can be automatically monitored.

Especially when a C-shaped steady rest is guided by the handling device in the overhead orientation already described, it is advantageous for safety reasons to automatically monitor the closed position of the adjustably mounted clamping arms. In the closed position, the clamping arms can also be secured against unintentional release, for example by an automatically actuated hydraulic valve and/or by an automatically actuated mechanical bolt and/or an automatically actuated clamping device to lock the adjustably mounted clamping arm in its closed position.

The method may include a first handling device which grasps the workpiece from the first workpiece store by means of at least one loading steady rest, deposits it in the loading steady rest and moves it into the processing position, and a second handling device separate from the first handling device which removes the workpiece from the processing position by means of at least one unloading steady rest, moves it to the second workpiece store and deposits it there by automatically releasing the unloading steady rest.

For example, the first handling device can be arranged on a lateral side next to the machine tool between the first workpiece store and the machine tool and be designed to automatically remove a workpiece to be processed in the machine tool from the first workpiece store and insert it into the machine tool or bring it into the processing position on the machine tool by means of at least one loading steady rest, so that the workpiece held by the at least one loading steady rest can be processed by the machine tool.

On the opposite lateral side next to the machine tool, the second handling device can be arranged between the machine tool and a second workpiece store and is designed to automatically remove the workpiece already processed in the machine tool from the processing position on the machine tool and move it to the second workpiece store by means of at least one unloading steady rest, so that the workpiece held by the at least one unloading steady rest can be deposited in the second workpiece store.

While the second handling device automatically removes the already processed workpiece from the processing position on the machine tool, the first handling device can simultaneously remove a new workpiece to be processed from the first workpiece store and move it to the processing position on the machine tool. In the processing position on the machine tool, the workpiece can be held temporarily or for the entire processing period by both the loading steady rests of the first handling device and the unloading steady rests of the second handling device.

The handling device can have at least one automatically adjustably mounted first steady rest and at least one automatically adjustably mounted second steady rest, wherein, during the supporting of a workpiece in the first steady rest during processing of the workpiece by the machine tool in a guide position of the first steady rest corresponding to the processing position of the workpiece, the second steady rest is moved into a storage position different from the guide position, in which the second steady rest is positioned outside the working region of the machine tool and workpiece.

If at least one of the handling devices has a plurality of steady rests, each of which can be adjusted by its own movement device, such as an automatically controllable drive, the movement devices can be set up and controlled to move only a smaller number than all steady rests into their guide positions, i.e., into the processing position of the workpiece, whereby at least one of the plurality of steady rests is not moved along with the workpiece, i.e., the workpiece is not gripped, but remains in a storage position in which the held steady rest does not grip the workpiece currently being handled by the respective processing device. This allows for the selection of a different number of steady rests to grip the workpiece.

Such a selection of the number of gripping steady rests can be determined, for example, based on the length of the workpiece to be gripped or on the weight of the workpiece to be gripped.

In these methods, at least one arm that can be automatically pivoted about a pivot axis and that carries at least one steady rest at its distal arm end can be used as a handling device.

In these methods, as an alternative to a pivotable arm as a handling device, at least one robot arm or a loading portal can be used, to the tool flange of which at least one steady rest is attached.

The method can utilize a press welding machine, a friction welding machine, a rotary friction welding machine or a magnetic arc welding machine as a machine tool.

The object is also achieved by a handling device, comprising:
a base frame,
at least one arm mounted on the base frame which can be automatically pivoted about a pivot axis and which has a distal arm end,
at least one steady rest arranged at the arm end of the arm, which steady rest has a main body and at least one clamping arm adjustably mounted to the main body between an open position and a closed position,
at least one automatically controllable drive designed to automatically pivot the arm between a receiving station in which the steady rest is moved into a receiving position in which a workpiece can be picked up from a first workpiece store by the steady rest, and a processing station in which a workpiece carried by the steady rest is brought into a processing position in a machine tool or into an intermediate position between the receiving position and the processing position, and/or
which is designed to automatically pivot the arm between a processing station in which a workpiece carried by the steady rest is in a processing position in a machine tool and a discharge station in which the steady rest is moved to a subsequent intermediate position or to a discharge position in which the workpiece can be deposited through the steady rest into a second workpiece store.

The handling device can have one pivotable arm or a plurality of pivotable arms. Each pivotable arm can be pivotally mounted on the base frame or on one of a plurality of coordinated base frames about a pivot axis running parallel to the axis of rotation of the machine tool or of the rotating workpiece to be processed in the machine tool. A plurality of arms can be automatically pivoted by a common drive of the handling device. Alternatively, each arm can be automatically pivoted by its own separate drive. For example, an electric drive or a hydraulic drive can be used as the drive mechanism. Each drive can be automatically controlled by a common control device.

The intermediate position between the pickup position and the processing position can be a waiting station for the workpiece handled by the steady rests. The waiting station can be a position as close as possible to the processing position. This allows for a reduction in cycle times, as a subsequent workpiece can already be moved from the receiving position to the intermediate position by the handling device, while a preceding workpiece is still being processed in the processing position in the machine tool. After the processing of the preceding workpiece is completed and this workpiece is removed from the processing position, only a short residual movement is needed, which can be carried out in a shorter time, to move the subsequent workpiece from the intermediate position into the processing position. In the intermediate position, pre-processing can also be carried out on the subsequent workpiece while the preceding workpiece is still being processed by the machine tool.

A similar process can also be carried out in the subsequent intermediate position, after the workpiece has left the processing position.

The handling device can have a coupling device which is designed and configured to automatically guide at least one steady rest between an initial position at the first workpiece store and the processing position in the machine tool synchronously with an automatic opening movement and/or closing movement of at least one clamping arm of the steady rest which is adjustably mounted between an open position and a closed position on a main body of the respective steady rest.

Similarly, the handling device or another handling device can have a further coupling device which is designed and configured to guide at least one steady rest between the processing position in the machine tool and an end position at the second workpiece store automatically synchronously with an automatic opening movement and/or closing movement of at least one clamping arm of the steady rest which is adjustably mounted on a main body of the steady rest between an open position and a closed position.

The coupling device can, for example, include a mechanical coupling mechanism that couples the movement of the steady rest to the movements of the adjustably mounted clamping arms of the steady rest.

In a special embodiment, however, the coupling device can be realized by means of a control-technical coupling, in that the control signals to the drives for moving the steady rests in space are synchronized by the control device with the control signals to the drives for moving the adjustably mounted clamping arms of each steady rest. This has the advantage that the respective synchronization can be individually set, programmed and/or changed as needed.

In the handling device, at least one steady rest can be designed as a C-shaped steady rest and the C-shaped steady rest can be arranged at the arm end of the pivotable arm of the handling device in such a way that, while holding a workpiece by means of the C-shaped steady rest in the processing position in the machine tool, the C-shaped steady rest is guided in such a way that a radial opening of the C-shaped steady rest points downward.

A C-shaped steady rest as such can have a main body on which a jaw-shaped clamping arm or two jaw-shaped clamping arms are pivotably mounted between an open position, in which a workpiece can be inserted in a radial direction into a receiving position on the C-shaped steady rest, and a closed position, in which the clamping arm encloses the inserted workpiece by more than 180 degrees. Each clamping arm can have a bearing point at its distal arm end, which can be, for example, a roller rotatably mounted at the distal arm end of the clamping arm, which, in the closed position, rolls on the outer shell wall of the workpiece when the tubular or circular cylindrical workpiece is rotated in the steady rest. A third bearing point can be formed on the main body. The third bearing point can also be a rotatably mounted roller, which, in the closed position of the clamping arms, rolls on the outer shell wall of the workpiece when the tubular or circular cylindrical workpiece is rotated in the steady rest. The third bearing point can be arranged on the main body between a first clamping arm and a second clamping arm. The third bearing point can be linearly adjustable on the main body, in a radial direction toward or away from the workpiece.

The respective steady rest can have at least one clamping arm adjustably mounted to a main body of the steady rest between an open position and a closed position, and the respective steady rest can have an automatically actuated hydraulic valve, an automatically actuated mechanical latch and/or an automatically actuated clamping device for locking the adjustably mounted clamping arm in its closed position.

A first handling device may be provided which grasps the workpiece from the first workpiece store by means of at least one loading steady rest, receives it into the loading steady rest and moves it into the processing position, and a second handling device separate from the first handling device may be provided which removes the workpiece from the processing position by means of at least one unloading steady rest, moves it to the second workpiece store and deposits it there by automatically releasing the unloading steady rest.

For example, the first handling device can be arranged on a lateral side next to the machine tool between the first workpiece store and the machine tool and be designed to automatically remove a workpiece to be processed in the machine tool from the first workpiece store and insert it into the machine tool or bring it into the processing position on the machine tool by means of at least one loading steady rest, so that the workpiece held by the at least one loading steady rest can be processed by the machine tool.

On the opposite lateral side next to the machine tool, the second handling device can be arranged between the machine tool and a second workpiece store and is designed to automatically remove the workpiece already processed in the machine tool from the processing position on the machine tool and move it to the second workpiece store by means of at least one unloading steady rest, so that the workpiece held by the at least one unloading steady rest can be deposited in the second workpiece store.

While the second handling device automatically removes the already processed workpiece from the processing position on the machine tool, the first handling device can simultaneously remove a new workpiece to be processed from the first workpiece store and move it to the processing position on the machine tool. In the processing position on the machine tool, the workpiece can be held temporarily or for the entire processing period by both the loading steady rests of the first handling device and the unloading steady rests of the second handling device.

The object is additionally achieved by a processing system, comprising:
a first workpiece store, which is designed and equipped for feeding, storing and/or singulating tubular or circular cylindrical workpieces to be processed,
a second workpiece store, designed and equipped for unloading and storing processed tubular or circular cylindrical workpieces,
a machine tool, in particular a press welding machine, a friction welding machine, a rotary friction welding machine or a magnetic arc welding machine, for processing the tubular or circular cylindrical workpieces, and
at least one handling device according to one of the described embodiments, which is automatically controlled by means of a control device, wherein the control device is designed and configured to carry out a method according to one of the described embodiments.

The first workpiece store can have a storage region in which a plurality of workpieces can be stored in a magazine, wherein the workpiece store can also have a singulation device which is designed to automatically remove a single workpiece separately from the storage region or magazine of the tool store and to pre-position it in a delivery region of the workpiece store separate from the storage region, so that the handling device can automatically remove the singulated workpiece pre-positioned at the delivery region by means of the movable steady rests.

Specific embodiments of the invention are explained in more detail in the following description with reference to the accompanying drawings. Individual features or combinations of features of these exemplary embodiments, possibly also considered individually or in further combinations, can represent advantageous features of alternative embodiment variants of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a flowchart of the steps in an exemplary inventive method,

FIG. 2 is a perspective view of an exemplary C-shaped steady rest,

FIG. 3 is a perspective view of an exemplary processing system with handling devices according to the invention, of which a first handling device grasps and picks up a workpiece from a first workpiece store by means of a plurality of loading steady rests, wherein a second handling device holds a preceding workpiece in a processing position by means of a plurality of unloading steady rests,

FIG. 4 is a perspective view of the exemplary processing system according to FIG. 3 with handling devices according to the invention, of which the first handling device holds the workpiece in the processing position by means of a plurality of loading steady rests, wherein the second handling device pivots the preceding workpiece out of the processing position by means of the plurality of unloading steady rests,

FIG. 5 is a perspective view of the exemplary processing system according to FIG. 3 with handling devices according to the invention, of which the first handling device holds the workpiece in the processing position by means of a plurality of loading steady rests, wherein the second handling device moves the preceding workpiece to a second workpiece store by means of the plurality of unloading steady rests and deposits it there by automatically releasing the unloading steady rests, and

FIG. 6 is a perspective view of the exemplary processing system according to FIG. 3 with handling devices according to the invention, of which both the first handling device and the second handling device hold the workpiece in the processing position or transfer it from the loading steady rests to the unloading steady rests.

### DETAILED DESCRIPTION

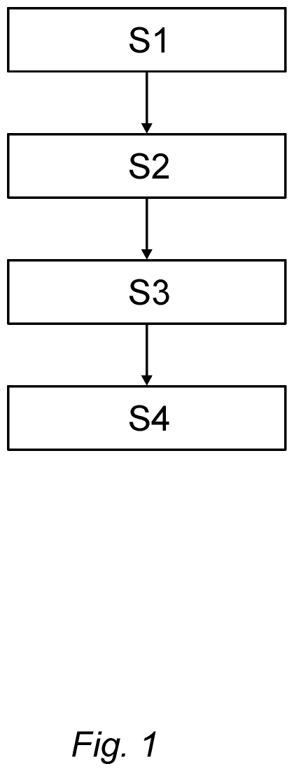

In FIG. 1 illustrates steps of an exemplary method according to principles of the invention for automatically feeding and/or unloading workpieces 1 at a machine tool 2 for rotary processing of tubular or circular cylindrical workpieces 1 are shown by means of a schematic flowchart.

In a first step S1 of the method, workpieces to be processed 1 are provided at a feeding first workpiece store 3.1 next to the machine tool 2.

In a second step S2 of the method, an unloading second workpiece store 3.2 is provided for receiving workpieces 1 processed in the machine tool 2.

In a third step S3 of the method, an automatically controllable handling device 4 is provided for automatically removing a workpiece 1 from the first workpiece store 3.1 and positioning the removed workpiece 1 in a processing position in the machine tool 2 and/or for automatically removing the processed workpiece 1 from the processing position in the machine tool 2 and placing the processed workpiece 1 in the second workpiece store 3.2.

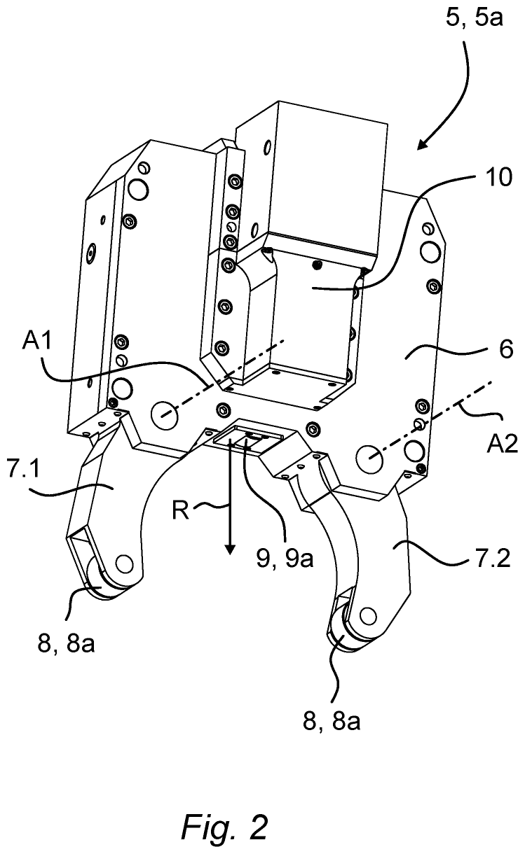

In a fourth step S4 of the method, at least one steady rest 5 (FIG. 2) is guided by the automatically controllable handling device 4 such that the handling device 4 grasps a workpiece 1 from the first workpiece store 3.1 by means of the at least one steady rest 5 and receives it into the steady rest 5, the workpiece 1 carried by the steady rest 5 is moved by the handling device 4 into the processing position and/or the handling device 4 removes the workpiece 1 grasped by the at least one steady rest 5 from the processing position, moves it to the second workpiece store 3.2 and deposits it there by automatically releasing the at least one steady rest 5, wherein during processing of the workpiece 1 by the machine tool 2, the workpiece 1 is guided in the at least one steady rest 5 by the handling device 4 holding the at least one steady rest 5 in a guide position corresponding to the processing position of the workpiece 1.

FIG. 2 shows an exemplary steady rest 5 in the design of a C-shaped steady rest 5a.

The C-shaped steady rest 5a shown in FIG. 2 has a main body 6 on which two clamping jaw-shaped clamping arms 7.1 and 7.2 are pivotably mounted between an open position (as shown in FIG. 2), in which a workpiece 1 can be inserted in a radial direction into a receiving position on the C-shaped steady rest 5a, and a closed position, in which the clamping arms 7.1 and 7.2 enclose the inserted workpiece 1 by more than 180 degrees, about the pivot axes A1 and A2. Each clamping arm 7.1 and 7.2 has a bearing point 8 at its distal arm end, which can be, for example, a roller 8a rotatably mounted at the distal arm end of the respective clamping arm 7.1 and 7.2, which, in the closed position, rolls on the outer shell wall of the workpiece 1 when the tubular or circular cylindrical workpiece 1 is rotated in the steady rest 5. In the present exemplary embodiment, a third bearing point 9 is formed on the main body 6. The third bearing point 9 also has a rotatably mounted roller 9a, which, in the closed position of the clamping arms 7.1 and 7.2, rolls on the outer shell wall of the workpiece 1 when the tubular or circular cylindrical workpiece 1 is rotated in the steady rest 5. The third bearing point 9 can be arranged on the main body 6 between the first clamping arm 7.1 and the second clamping arm 7.2. The third bearing point 9 can be linearly adjustable on the main body 6, namely in a radial direction R toward or away from the workpiece 1. The steady rest 5 has a drive 10 which is designed for automatically controlled and optimally synchronized pivoting of the clamping arms 7.1 and 7.2 and linear adjustment of the bearing point 9.

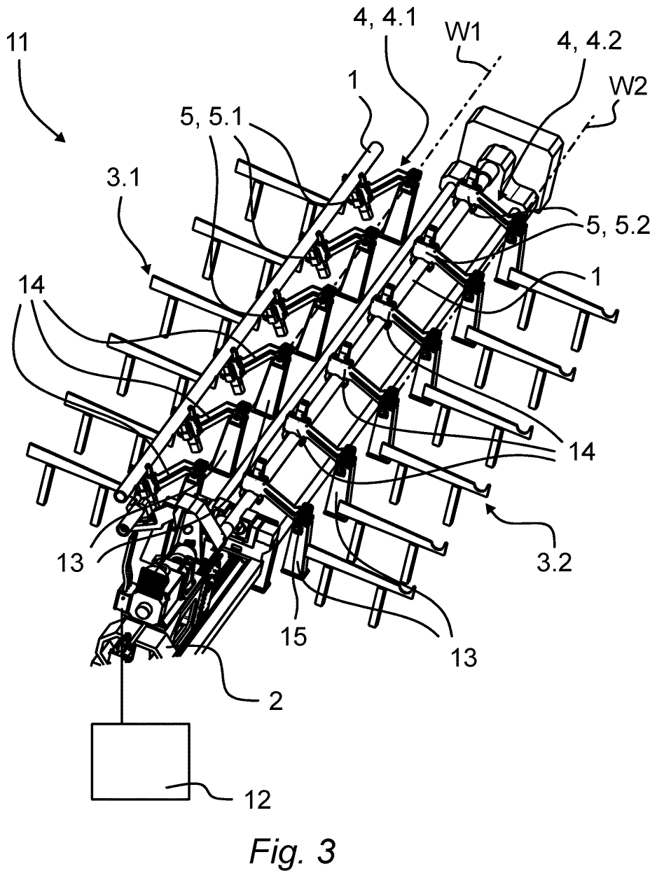

FIG. 3 to FIG. 6 each show an exemplary embodiment of a processing system 11 with which the method can be carried out.

The processing system 11 includes the first workpiece store 3.1, which is designed and equipped for feeding, storing and/or singulating tubular or circular cylindrical workpieces 1 to be processed.

The processing system 11 comprises the second workpiece store 3.2, which is designed and equipped for unloading processed tubular or circular cylindrical workpieces 1.

The processing system 11 also comprises the machine tool 2, which in the present embodiment is in particular a press welding machine, a friction welding machine, a rotary friction welding machine or a magnetic arc welding machine, for processing the tubular or circular cylindrical workpieces 1.

A control device 12 is designed and configured to carry out the described method and to automatically control the two handling devices 4 accordingly.

The first handling device 4.1 is designed to grasp the workpiece 1 from the first workpiece store 3.1 by means of loading steady rests 5.1, to receive it into the loading steady rests 5.1 and to move it into the processing position.

The second handling device 4.2, separate from the first handling device 4.1, is designed to remove the workpiece 1 from the processing position by means of unloading steady rests 5.2, to move it to the second workpiece store 3.2 and to deposit it there by automatically releasing the unloading steady rests 5.2.

In the situation shown in FIG. 3, the loading steady rests 5.1 of the first handling device 4.1 are in a station in which a workpiece 1 to be processed has been removed from the first workpiece store 3.1, but has not yet been pivoted into the processing position on the machine tool 2. In the situation shown in FIG. 3, a preceding workpiece 1 is in the processing position in the machine tool 2 and is held in the processing position by the unloading steady rests 5.2 of the second handling device 4.2.

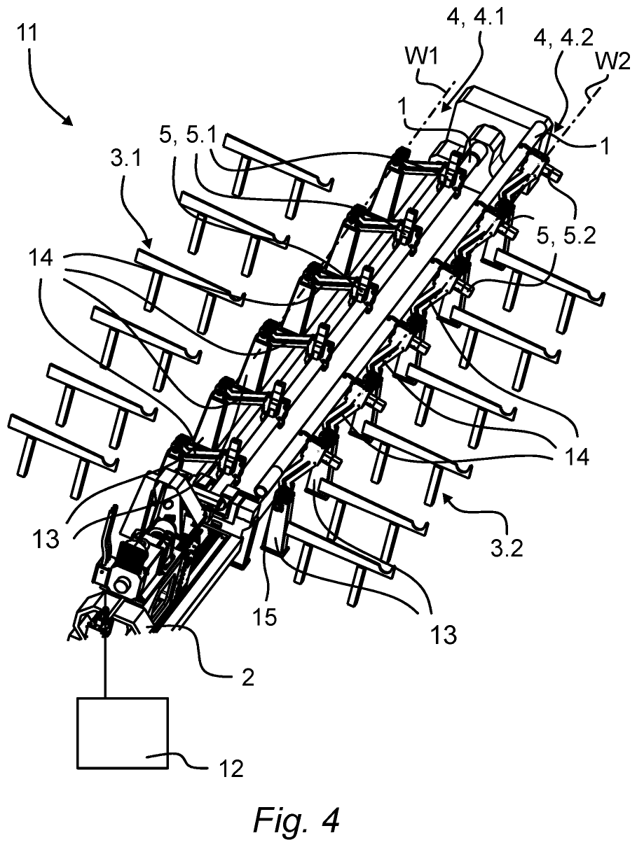

In the following situation shown in FIG. 4, the loading steady rests 5.1 of the first handling device 4.1 are in a station in which the workpiece 1 to be processed is pivoted into the processing position on the machine tool 2. Before this is possible, the unloading steady rests 5.2 of the second handling device 4.2, as shown in FIG. 4, have pivoted out of the processing position and have removed the already processed workpiece 1 from the processing position on the machine tool 2, so that the processing position is free for positioning the workpiece 1 handled by the loading steady rests 5.1 of the first handling device 4.1.

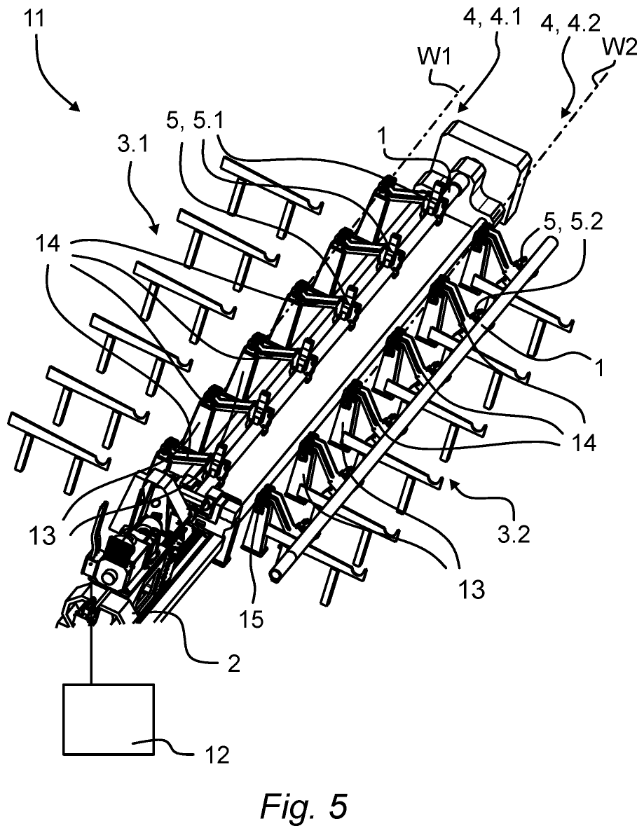

In the further situation shown in FIG. 5, the loading steady rests 5.1 of the first handling device 4.1 are in a processing station in which the workpiece 1 handled by the loading steady rests 5.1 of the first handling device 4.1 is in the processing position. During the processing of this workpiece 1 by the machine tool 2, the loading steady rests 5.1 of the first handling device 4.1 remain in this processing station. The workpiece 1, which was already processed in the previous work step, is at this time deposited on the second workpiece store 3.2 by the unloading steady rests 5.2 of the second handling device 4.2, as shown in FIG. 5.

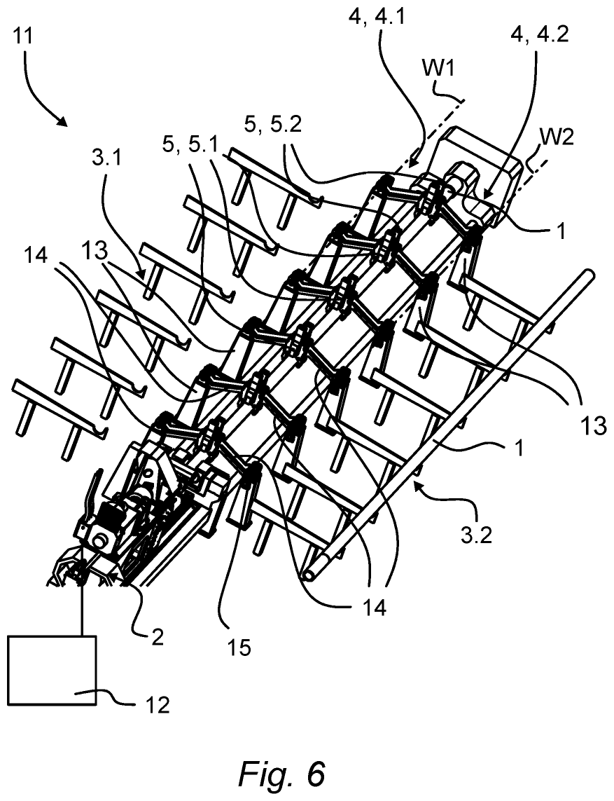

In the further situation shown in FIG. 6, the loading steady rests 5.1 of the first handling device 4.1 are in the processing station, in which the workpiece 1 handled by the loading steady rests 5.1 of the first handling device 4.1 is in the processing position, and the unloading steady rests 5.2 of the second handling device 4.2 have been pivoted back from the second workpiece store 3.2 into the processing station, in which the unloading steady rests 5.2 of the second handling device 4.2 grip the workpiece 1 in the processing position, so that the workpiece 1 is held by both the loading steady rests 5.1 and the unloading steady rests 5.2. In a final situation not shown, the loading steady rests 5.1 can now be released from the workpiece 1, moved back to the starting position according to FIG. 3, in order to retrieve a new workpiece 1 from the first workpiece store 3.1, while the previous workpiece, after its processing in the machine tool 2, is transferred by the unloading steady rests 5.2 of the second handling device 4.2 to the second workpiece store 3.2 and deposited there according to FIG. 5.

The handling device 4 shown in FIG. 3 to FIG. 6 can therefore have at least a base frame 13 and arms 14 mounted on it which are automatically pivotable about a common pivot axis W1, W2, at the distal arm ends of which at least one steady rest 5 is attached or mounted.

At least one automatically controllable drive 15 is designed for automatically pivoting the arms 14 between a receiving station in which the steady rests 5 are moved into a receiving position in which a workpiece 1 from the first workpiece store 3.1 can be received by the steady rests 5, and a processing station in which the workpiece 1 carried by the steady rests 5 is brought into the processing position in the machine tool 2 or into an intermediate position.

Alternatively or additionally, the same drive 15 or another automatically controllable drive 15 (not shown) can be designed for automatically pivoting the arms 14 between the processing station in which the workpiece 1 carried by the steady rests 5 is in the processing position in the machine tool 2 and a discharge station in which the steady rests 5 are moved into a discharge position in which the workpiece 1 can be deposited through the steady rests 5 into the second workpiece store 3.2.

The machine tool 2 can in particular be a press welding machine, a friction welding machine, a rotary friction welding machine or a magnetic arc welding machine.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

1. Method for automatically feeding and/or unloading workpieces (1) at a machine tool (2) for rotary processing of tubular or circular cylindrical workpieces (1), comprising the steps of:
providing workpieces to be processed (1) at a feeding first workpiece store (3.1) next to the machine tool (1),
providing an unloading secondary workpiece store (3.2) for receiving workpieces (1) processed in the machine tool (2),
providing an automatically controllable handling device (4) for automatically removing a workpiece (1) from the first workpiece store (3.1) and positioning the removed workpiece (1) in a processing position in the machine tool (2) and/or for automatically removing the processed workpiece (1) from the processing position in the machine tool (2) and depositing the processed workpiece (1) in the second workpiece store (3.2),
guiding at least one steady rest (5) by means of the automatically controllable handling device (4) such that the handling device (4) grasps a workpiece (1) from the first workpiece store (3.1) by means of the at least one steady rest (5) and receives it into the steady rest (5), the workpiece (1) carried by the steady rest (5) is moved by the handling device (4) into the processing position and/or the handling device (4) removes the workpiece (1) grasped by means of the at least one steady rest (5) from the processing position, moves it to the second workpiece store (3.2) and deposits it there by automatically releasing the at least one steady rest (5), wherein during processing of the workpiece (1) by the machine tool (2), the workpiece (1) in the at least one steady rest (5) is guided by the handling device (4) holding the at least one steady rest (5) in a guide position corresponding to the processing position of the workpiece (1).

2. Method according to claim 1, characterized in that the automatic guiding of the at least one steady rest (5) by means of the handling device (4) between an initial position at the first workpiece store (3.1) and the processing position in the machine tool (2) and/or between the processing position in the machine tool (2) and an end position at the second workpiece store (3.2) is carried out synchronously with an automatic opening movement and/or closing movement of at least one clamping arm (7.1, 7.2) of the steady rest (5) which is adjustably mounted on a main body (6) of the steady rest (5) between an open position and a closed position.

3. Method according to claim 1, characterized in that a C-shaped steady rest (5a) is used as the steady rest (5) and the automatic guiding of the at least one C-shaped steady rest (5a) by means of the handling device (4) is carried out in such a way that, while holding the workpiece (1) by means of the C-shaped steady rest (5a) in the processing position in the machine tool (2), the C-shaped steady rest (5a) is guided in such a way that the radial opening of the C-shaped steady rest (5a) points downward.

4. Method according to claim 1, characterized in that the steady rest (5) has at least one clamping arm (7.1, 7.2) adjustably mounted on a main body (6) of the steady rest (5) between an open position and a closed position and, after a workpiece (1) has been grasped and picked up by the steady rest (5) guided by the handling device (4), the closed position of the at least one adjustably mounted clamping arm (7.1, 7.2) is automatically monitored.

5. Method according to claim 1, characterized in that a first handling device (4.1) is provided which grasps the workpiece (1) from the first workpiece store (3.1) by means of at least one loading steady rest (5.1), receives it into the loading steady rest (5.1) and moves it into the processing position, and a second handling device (4.2) separate from the first handling device (4.1) is provided which removes the workpiece (1) from the processing position by means of at least one unloading steady rest (5.2), moves it to the second workpiece store (3.2) and deposits it there by automatically releasing the unloading steady rest (5.2).

6. Method according to claim 1, characterized in that the handling device (4) has at least one automatically adjustably mounted first steady rest (5) and at least one automatically adjustably mounted second steady rest (5) independent of the first steady rest (5), wherein, while storing a workpiece (1) in the first steady rest (5) during processing of the workpiece (1) by the machine tool (2) in a guide position of the first steady rest (5) corresponding to the processing position of the workpiece (1), the second steady rest (5) is moved into a storage position different from the guide position, in which storage position the second steady rest (5) is positioned outside the working region of the machine tool (2) and workpiece (1).

7. Method according to claim 1, characterized in that at least one arm (14) which can be automatically pivoted about a pivot axis (W1, W2) and which carries at least one steady rest (5) at its distal arm end is used as a handling device (4).

8. Method according to claim 1, characterized in that at least one robot arm or loading portal is used as the handling device (4), to the tool flange of which the at least one steady rest (5) is attached.

9. Method according to claim 1, characterized in that a press welding machine, a friction welding machine, a rotary friction welding machine or a magnetic arc welding machine is used as the machine tool (2).

10. Handling device (4), comprising:
a base frame (13),
at least one arm (14) automatically pivotably mounted about a pivot axis (W1, W2) on the base frame (13), which arm has a distal arm end,
at least one steady rest (5) arranged at the arm end of the arm (14), which steady rest has a main body (6) and at least one clamping arm (7.1, 7.2) adjustably mounted on the main body (6) between an open position and a closed position,
at least one automatically controllable drive (15) designed for automatically pivoting the arm (14) between a receiving station in which the steady rest (5) is moved into a receiving position in which a workpiece (1) can be picked up from a first workpiece store (3.1) by the steady rest (5), and a processing station in which a workpiece (1) carried by the steady rest (5) is brought into a processing position in a machine tool (2) or into an intermediate position between the receiving position and the processing position, and/or
which is designed to automatically pivot the arm (14) between a processing station in which a workpiece (1) carried by the steady rest (5) is in a processing position in a machine tool (2) and a discharge station in which the steady rest (5) is moved to a subsequent intermediate position or to a discharge position in which the workpiece (1) can be deposited by the steady rest (5) into a second workpiece store (3.2).

11. Handling device (4) according to claim 10, characterized in that the handling device (4) has a coupling device which is designed and configured to guide at least one steady rest (5) between an initial position at the first workpiece store (3.1) and the processing position in the machine tool (2) and/or between the processing position in the machine tool (2) and an end position at the second workpiece store (3.2) automatically synchronously with an automatic opening movement and/or closing movement of at least one clamping arm (7.1, 7.2) of the steady rest (5) adjustably mounted on a main body (6) of the steady rest (5) between an open position and a closed position.

12. Handling device (4) according to claim 10, characterized in that the at least one steady rest (5) is designed as a C-shaped steady rest (5a) and the C-shaped steady rest (5a) is arranged on the arm end of the pivotable arm (14) of the handling device (5) such that, during the holding of a workpiece (1) by means of the C-shaped steady rest (5a), in the processing position in the machine tool (2), the C-shaped steady rest (5a) is guided in such a way that a radial opening of the C-shaped steady rest (5a) points downward.

13. Handling device (4) according to claim 10, characterized in that the steady rest (5) has at least one clamping arm (7.1, 7.2) adjustably mounted on a main body (6) of the steady rest (5) between an open position and a closed position and the steady rest (5) has an automatically actuated hydraulic valve, an automatically actuated mechanical latch and/or an automatically actuated clamping device for locking the adjustably mounted clamping arm (7.1, 7.2) in its closed position.

14. Handling device (4) according to claim 10, characterized in that a first handling device (4.1) is provided which grasps the workpiece (1) from the first workpiece store (3.1) by means of at least one loading steady rest (5.1), receives it into the loading steady rest (5.1) and moves it into the processing position, and a second handling device (5.2) separate from the first handling device (5.1) is provided which removes the workpiece (1) from the processing position by means of at least one unloading steady rest (5.2), moves it to the second workpiece store (3.2) and deposits it there by automatically releasing the unloading steady rest (5.2).

15. Processing system (11), comprising:
a first workpiece store (3.1) which is designed and equipped for feeding, storing and/or singulating tubular or circular cylindrical workpieces (1) to be processed,
a second workpiece store (3.2) which is designed and equipped for unloading processed tubular or circular cylindrical workpieces (1),
a machine tool (2), in particular a pressure welding machine, a friction welding machine, a rotary friction welding machine or a magnetic arc welding machine, for processing the tubular or circular cylindrical work-pieces (1), and
at least one handling device which is automatically controlled by means of a control device (12), wherein the control device (12) is designed and configured to carry out a method according to claim 1.
